(19) United States
(12) Patent Application Publication
(10) Pub. No.: US 2026/0213930 A1
(43) Pub. Date: Jul. 23, 2026

(54) METHOD OF ESTABLISHING CONFIDENTIAL ARTIFICIAL INTELLIGENCE INFRASTRUCTURE AND COMPUTING DEVICE FOR DEPLOYING ARTIFICIAL INTELLIGENCE MODEL

(71) Applicant: HUAWEI TECHNOLOGIES CO., LTD., Shenzhen (CN)

(72) Inventors: Aritra Dhar, Zurich (CH); Lukas CAVIGELLI, Zurich (CH); Clement THORENS, Zurich (CH)

(21) Appl. No.: 19/570,528

(22) Filed: Mar. 18, 2026

Related U.S. Application Data
(63) Continuation of application No. PCT/EP2023/075840, filed on Sep. 19, 2023.

(51) Int. Cl. H04L 9/08; H04L 9/32

(52) U.S. Cl. CPC H04L 9/0838; H04L 9/3236

(57) ABSTRACT

For establishing confidential AI infrastructure, a first key exchange is performed to establish a first shared secret key between an AI model provider and a computing device configured for deploying an AI model, and a second key exchange is performed to establish a second shared secret key between the computing device and a data provider for providing an input data to the AI model. The computing device receives the AI model and the input data encrypted with different secret keys. A message authentication code, MAC, of the input data is send from the data provider to the computing device and the AI model provider, and the AI model provider sends a first token of the input data calculated with the MAC to the computing device.

### CROSS-REFERENCE TO RELATED APPLICATIONS

This application is a continuation of International Application No. PCT/EP2023/075840, filed on Sep. 19, 2023, the disclosure of which is hereby incorporated by reference in its entirety.

### TECHNICAL FIELD

The present disclosure relates generally to the field of data security and more specifically, to a method of establishing a confidential artificial intelligence, AI, infrastructure. Furthermore, the present disclosure relates more specifically to a computing device for deploying an AI model.

### BACKGROUND

Generally, confidential computing refers to a set of cryptographic protocols that are considered a gold standard for processing data without revealing any information about the data and without relying on assistance from a trusted third party. These cryptographic protocols include Yao's garbled circuit, oblivious transfer, zero-knowledge proof, and the like. However, using such cryptographic protocols on different platforms is prohibitively expensive due to high computational requirements, memory demands, and increased message exchange.

Conventionally, trusted execution environments, TEEs, such as advanced micro devices, AMD, secure encrypted virtualization, SEV, advanced RISC machines, ARM, TrustZone, RISC-V keystone, and the like strike a balance by achieving confidential computing through a trade-off in trust assumption. This often involves trusting a processor package, which is also referred to as a silicon root of trust, S-RoT. The TEEs significantly reduce a trusted computing base, TCB, and provide security to applications known as enclaves while eliminating the need to trust the underlying operating system, OS, and hypervisor. However, such an approach reduces an attack surface by using isolation mechanisms provided by the CPU, effectively and excluding all software from the TCB. In such TEEs, even hardware components like memory are considered untrusted. In addition to isolating enclaves from untrusted OS environments, another crucial security feature of TEEs is remote attestation. The remote attestation involves a remote verifier ensuring that a platform (i.e., a legitimate platform) is running the enclave with the correct code. However, the implementation of remote attestation mechanisms often requires extensive hardware changes to achieve both data security and optimized system performance, which is not desirable.

Currently, there is no holistic approach or system that can be relied upon that deals with a tokenized inference for confidential models. Existing confidential clouds rely on standard TEEs to establish a secure channel from a client end to the TEE enclaves, with all computations executed inside the TEE enclave. However, this approach falls short of ensuring both data integrity and confidentiality, which is again not desirable. Additionally, the existing confidential cloud solutions do not provide secure contractual agreements between a model provider and a data provider and are often tied to specific platforms, limiting their flexibility and usability, which is again not desirable. As a result, there exists a technical problem of how to provide an efficient way of sharing encrypted models with the data provider without revealing any information about the confidential data with enhanced overall data security and confidentiality.

Therefore, in light of the foregoing discussion, there exists a need to overcome the aforementioned drawbacks associated with the conventional methods of establishing confidential AI infrastructure and conventional computing devices for deploying an AI model.

### SUMMARY

The present disclosure provides a method of establishing a confidential artificial intelligence, AI, infrastructure. Furthermore, the present disclosure provides a computing device for deploying an AI model. The present disclosure provides a solution to the existing problem of how to provide an efficient way of sharing encrypted models with the data provider without revealing any information about the confidential data with enhanced overall data security and confidentiality. An objective of the present disclosure is to provide a solution that overcomes at least partially the problems encountered in the prior art and provides an improved method of establishing the confidential AI infrastructure and the computing device for deploying an AI model, such as by using tokenized confidential model inference in the confidential AI Infrastructure.

One or more objectives of the present disclosure are achieved by the solutions provided in the enclosed independent claims. Advantageous implementations of the present disclosure are further defined in the dependent claims.

In one aspect, the present disclosure provides a method of establishing confidential artificial intelligence, AI, infrastructure. The method includes performing a first key exchange to establish a first shared secret key between an AI model provider and a computing device configured for deploying an AI model, performing a second key exchange to establish a second shared secret key between the computing device and a data provider for providing an input data to the AI model and sending the AI model encrypted with the first shared secret key from the AI model provider to the computing device. Furthermore, the method includes decrypting, by the computing device, the received encrypted AI model with the first shared secret key, sending the input data encrypted with the second shared secret key from the data provider to the computing device, sending a message authentication code, MAC, of the input data obtained with the second shared secret key from the data provider to the computing device and the AI model provider, calculating, by the AI model provider, a first token of the input data as a cryptographic commitment on the MAC received from the data provider using the first shared secret key, sending the first token of the input data from the AI model provider to the computing device, decrypting, by the computing device, the encrypted input data and verifying the MAC received from the data provider with the second shared secret key, calculating, by the computing device, a second token of the input data for the AI model using the first shared secret key and the second shared secret key, using, by the computing device, the decrypted input data on the AI model to obtain an inference result, if the second token of the input data for the AI model is identical to the first token of the input data received from the AI model provider, or setting null data as the inference result otherwise, and sending the inference result encrypted with the second shared secret key from the computing device to the data provider.

The disclosed method is used for establishing a confidential AI infrastructure that includes the establishment of the key exchange (e.g., the first key exchange, the second key exchange, and the like) to ensure secure exchanges of encrypted AI models and data, thereby ensuring that the input data remains protected during data transmission and data processing. Further, the key exchange reduces the risk of data breaches and unauthorized access. Furthermore, the method is used to generate tokens that impose security properties on the input data that assist in determining the quantity of the input data the data provider is allowed to use for inference with the given confidential AI model. The data providers are allowed to share the input data with the computing device without revealing the data to the AI model provider. This preserves the data confidentiality of the input data while enabling AI model inference. The method includes verifying the integrity of the AI model, which ensures that the input data is not tampered during the data transmission, which enhances the overall authenticity of the AI model. Moreover, the method supports collaboration among multiple parties, including data providers and model providers, enabling secure data sharing and the utilization of AI models, fostering cooperation in AI-related projects, and making the AI model adaptable to a variety of collaborative platforms. The inclusion of AI accelerators in the computing device disclosed in the method enhances the efficiency and the computation speed of AI model inference, making the computing device suitable for real-time applications. Additionally, the method can be applied to large language models (LLMs) where queries from multiple data providers are merged or where a single data provider runs the inference workloads on multiple models simultaneously. Hence, the method is used for establishing a secure and confidential environment for AI-related operations, facilitating collaboration while ensuring data security, reliability, model integrity, and efficiency for the AI model deployment.

In an implementation form, the method further includes sending a first cryptographic hash of the AI model from the AI model provider to the data provider, sending a second cryptographic hash of the AI model decrypted with the first shared secret key from the computing device to the data provider, and instructing, by the data provider, the computing device to proceed with decrypting the encrypted input data, if the second cryptographic hash of the AI model is identical to the first cryptographic hash of the AI model.

Advantageously, such an implementation allows the data provider to verify the authenticity of the AI model before allowing the decryption of the input data, ensuring data integrity and security.

In a further implementation form, the method further includes performing a third key exchange to establish a third shared secret key between the computing device and a second data provider for providing a second input data to the AI model, sending the second input data encrypted with the third shared secret key from the second data provider to the computing device, sending a second message authentication code, MAC, of the second input data obtained with the third shared secret key by the second data provider to the computing device and the AI model provider, calculating, by the AI model provider, a first token of the second input data as a cryptographic commitment on the second MAC received from the second data provider using the first shared secret key, sending the first token of the second input data from the AI model provider to the computing device, decrypting, by the computing device, the encrypted second input data and verifying the second MAC received from the second data provider with the third shared secret key, calculating, by the computing device, a second token of the second input data for the AI model using the first shared secret key and the third shared secret key, using, by the computing device, the decrypted second input data on the AI model to obtain a second inference result, if the second token of the second input data for the AI model is identical to the first token of the second input data received from the AI model provider, or setting null data as the second inference result otherwise, and sending the second inference result encrypted with the third shared secret key from the computing device to the second data provider.

Beneficially, the calculation of the second token of the input data for the AI model using the first shared secret key and the third shared secret key enhances the data security and data integrity by ensuring that the second input data is received from the authorized data source (i.e., the authorized data provider) only.

In a further implementation form, the method further includes sending a first cryptographic hash of the AI model from the AI model provider to the second data provider, sending a second cryptographic hash of the AI model decrypted with the third shared secret key from the computing device to the second data provider, and instructing, by the second data provider, the computing device to proceed with decrypting the encrypted second input data, if the second cryptographic hash of the AI model is identical to the first cryptographic hash of the AI model.

In such an implementation, the method is used to allow the second data provider to verify the authenticity of the AI model before allowing the decryption of the second input data, ensuring data integrity and security.

In a further implementation form, the method further includes performing a fourth key exchange to establish a fourth shared secret key between a second AI model provider and the computing device, sending a second AI model encrypted with the fourth shared secret key from the second AI model provider to the computing device, decrypting, by the computing device, the received encrypted second AI model with the fourth shared secret key, sending a message authentication code, MAC, of the input data obtained with the second shared secret key from the data provider to the second AI model provider, calculating, by the second AI model provider, a first token of the input data as a cryptographic commitment on the MAC received from the data provider using the fourth shared secret key, sending the first token of the input data from the second AI model provider to the computing device, calculating, by the computing device, a second token of the input data for the second AI model using the fourth shared secret key and the second shared secret key, using, by the computing device, the decrypted input data on the second AI model to obtain a third inference result, if the second token of the input data for the second AI model is identical to the first token of the input data received from the second AI model provider, or setting null data as the third inference result otherwise, and sending the third inference result encrypted with the second shared secret key from the computing device to the data provider.

By utilizing the decrypted input data with the second AI model, the computing device obtains a third inference result, which is only produced if the second token matches the first token, ensuring the accuracy and reliability of the inference process. Additionally, the computing device sends the encrypted third inference result back to the data provider, maintaining the security and confidentiality of the outcome.

In a further implementation form, the method further includes sending a first cryptographic hash of the second AI model from the second AI model provider to the data provider, sending a second cryptographic hash of the second AI model decrypted with the fourth shared secret key from the computing device to the data provider, and instructing, by the data provider, the computing device to proceed with decrypting the input data, if the second cryptographic hash of the second AI model is identical to the first cryptographic hash of the second AI model.

Advantageously, the method provides a reliable and secure mechanism for ensuring that the input data is decrypted using the correct and unmodified AI model, thereby enhancing the overall security of the data transmission.

In another aspect, the present disclosure provides a computing device for deploying an artificial intelligence, AI, model. The computing device being configured for participating in a first key exchange to establish a first shared secret key between the computer device and an AI model provider, participating in a second key exchange to establish a second shared secret key between the computing device and a data provider for receiving an input data to the AI model, receiving the AI model encrypted with the first shared secret key from the AI model provider, decrypting the received encrypted AI model with the first shared secret key, and receiving the input data encrypted with the second shared secret key and a message authentication code, MAC, of the input data obtained with the second shared secret key from the data provider. Moreover, the data provider sends the MAC of the input data obtained with the second shared secret key to the AI model provider. Furthermore, the computing device receives a first token of the input data from the AI model provider, wherein the first token of the input data is calculated by the AI model provider as a cryptographic commitment on the MAC received from the data provider using the first shared secret key, decrypting the encrypted input data and verifying the MAC received from the data provider with the second shared secret key, calculating a second token of the input data for the AI model using the first shared secret key and the second shared secret key, using the decrypted input data on the AI model to obtain an inference result, if the second token of the input data for the AI model is identical to the first token of the input data received from the AI model provider, or setting null data as the inference result otherwise, and sending the inference result encrypted with the second shared secret key to the data provider.

The computing device achieves all the advantages and technical effects of the method of the present disclosure.

It is to be appreciated that all the aforementioned implementation forms can be combined.

It has to be noted that all devices, elements, circuitry, units, and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIGS. 1A and 1B collectively depict a flow chart of a method of establishing confidential artificial intelligence, AI, infrastructure, in accordance with an embodiment of the present disclosure;

FIG. 2 is a block diagram of a computing device for deploying an artificial intelligence, AI, model, in accordance with an embodiment of the present disclosure;

FIG. 3 is a sequence diagram that depicts an execution of establishing a confidential artificial intelligence infrastructure, in accordance with an embodiment of the present disclosure;

FIG. 4 depicts an exemplary illustration that depicts a plurality of artificial intelligence model providers and a plurality of data providers that are connected with a computing device to establish a confidential AI infrastructure, in accordance with an embodiment of the present disclosure;

FIG. 5 is a sequence diagram that depicts a token generation for a plurality of data providers, in accordance with an embodiment of the present disclosure; and

FIG. 6 is a sequence diagram that depicts a model execution for the plurality of data providers, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

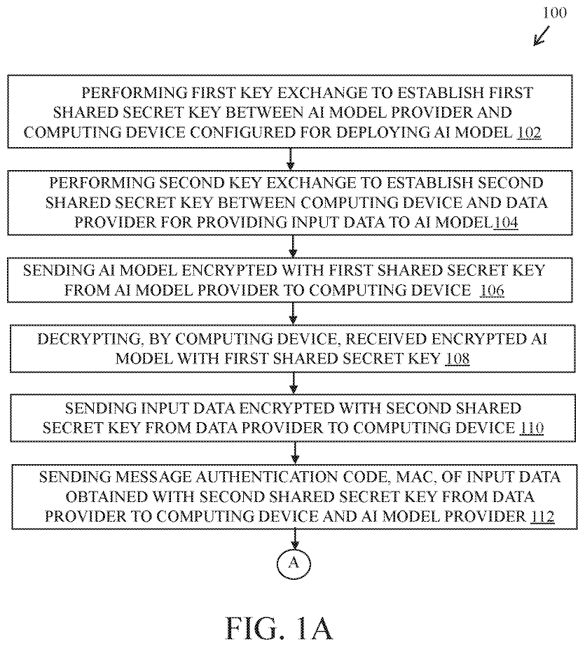

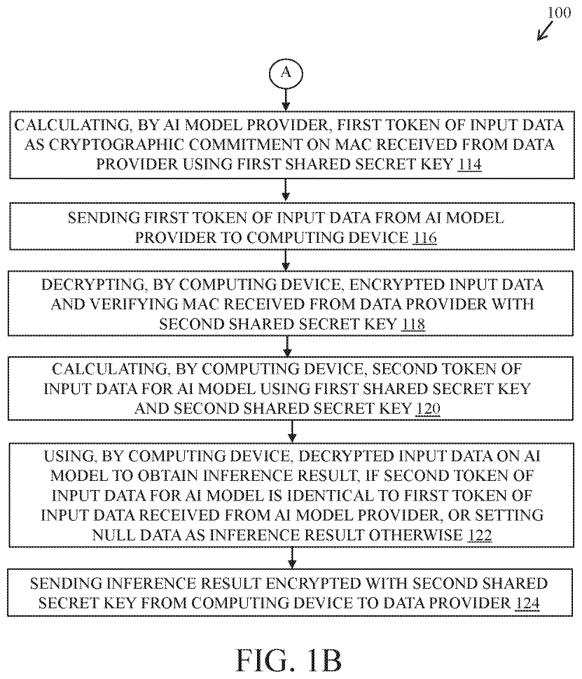

FIGS. 1A and 1B collectively depict a flow chart of a method of establishing confidential artificial intelligence, AI, infrastructure, in accordance with an embodiment of the present disclosure. With reference to FIG. 1A and FIG. 1B, there is shown a flowchart of a method 100 that includes steps 102 to 124.

There is provided the method 100 of establishing confidential artificial intelligence, AI, infrastructure. The method 100 is used to protect a confidential AI model and a data provider from any untrusted software stack or any untrusted cloud services provider. Moreover, the data provider and the confidential AI model providers are mutually distrusting parties. Therefore, it is required to establish a safe and secure network connection between both the parties in order to allow secure data transmission with maintained data confidentiality and data integrity. The method 100 can be used in a computing device, which is capable of accelerating neural network computation, a cloud computing software stack in which the AI model providers, and the data provider (such as a hospital with patient's data, or a private individual) that provides the encrypted AI model and the data so that the computing device can run inference workload with the input data on the rented AI model. Thus, the computing device uses the method 100 to establish the confidential AI infrastructure without revealing the actual data to ensure safe and secure data transmission and data processing.

At step 102, the method 100 includes performing a first key exchange to establish a first shared secret key between an AI model provider and a computing device configured for deploying an AI model. The first shared secret key is a cryptographic key, such as a security key, private key, and the like, that is exchanged between the AI provider and the computing device for deploying the AI model. Moreover, the AI model provider refers to an entity or organization that creates, develops, or supplies AI models, which are the core components of various AI applications and systems. Furthermore, the first shared key is known only to the AI model provider and the computing device. In an implementation, the first shared secret key exchange starts with an exchange of public keys of each of the parties (i.e., the AI model provider and the computing device), such as by using public key crypto and deriving a key for a symmetric key (e.g., advanced encryption standard—Galois counter mode, AES-GCM, encryption) encryption. As a result, the first key exchange is used to establish a secure channel between the AI provider and the computing device configured for deploying the AI model to allow safe and secure communication with reduced risk of data breach and unauthorized access.

Furthermore, at step 104, the method 100 includes performing a second key exchange to establish a second shared secret key between the computing device and the data provider for providing an input data to the AI model. The second shared secret key refers to another cryptographic key, such as a security key, private key, and the like, that is exchanged between the computing device and the AI provider for providing the input data to the AI model. The second shared secret key is exchanged between the computing device and the data provider for providing the input data to the AI model. For example, the second key exchange is performed to establish the second shared secret key between the computing device and the data provider to provide the input data to the AI model to protect the patient data, for example, the name of the patient, age or the patient, gender, prescription, and the like during the data transmission and the data processing. Moreover, the computing device and the data providers are required to set up a secure communication channel by exchanging cryptographic keys, such as the first shared secret key and the second shared secret key between the AI model and the data provider to ensure data security and data confidentiality.

Furthermore, at step 106, the method 100 includes sending the AI model encrypted with the first shared secret key from the AI model provider to the computing device. After the establishment of the secure communication channel, the AI model provider sends the AI model encrypted with the first shared secret key to the computing device. The encryption refers to a process for converting a plain readable AI model into a coded form that can be accessed through the first shared secret key only. Moreover, the encryption of the AI model ensures safety, and security, and eliminates the risk of potential threats during the transmission of the AI model from the AI model provider to the computing device. However, even if someone intercepts the AI model during transmission, then, in such a case, such interception can be prevented due to encryption of the AI model. As a result, the confidentiality, integrity, and reliability of the AI model are maintained.

Furthermore, at step 108, the method 100 includes decrypting, by the computing device, the received encrypted AI model with the first shared secret key. In other words, the computing device, which is configured to receive the encrypted AI model from the AI model provider is configured to perform decryption of the received encrypted AI model. In an implementation, the decryption refers to a process of converting a coded form of the AI model into a plain readable form. Moreover, the computing device utilizes the first shared secret key that was exchanged earlier to perform the decryption of the AI model. As a result, the computing device is configured to convert the encrypted AI model back into its original and usable state with improved data security and reliability.

Furthermore, at step 110, the method 100 includes sending the input data encrypted with the second shared secret key from the data provider to the computing device. Firstly, the data provider is configured to encrypt the input data to protect the data from unauthorized access. After that, the data provider sends the input data (e.g., a file or any other data, such as image, multi-media, and the like) to the computing device along with the second shared secret key. Moreover, the second shared key is used for further decrypting the data. As a result, the encryption of the input data ensures that the input data remains confidential and secure during the data transfer between the data provider and the computing device.

Furthermore, at step 112, the method 100 includes sending a message authentication code, MAC, of the input data obtained with the second shared secret key from the data provider to the computing device and the AI model provider. In other words, the data provider is configured to generate a special code that is called the MAC of the input data. The MAC is derived from the input data and serves as a one-way commitment to the input data. The data provider sends the MAC of the input data to the AI model provider and the computing device. After the creation of the MAC, the data provider sends the MAC to the computing device and the AI model provider to verify that the received data has not been tampered with and is obtained from the authorized data provider. As a result, the creation of the MAC based on the input data and the second shared secret key is used to ensure data authenticity and data integrity during the data transmission.

Furthermore, at step 114, the method 100 includes calculating, by the AI model provider, a first token of the input data as a cryptographic commitment on the MAC received from the data provider using the first shared secret key. In other words, the AI model calculates the first token of the input data by calculating a cryptographic commitment on the MAC received from the data provider using the first shared secret key. Moreover, such calculation by the AI model provider is used to impose security properties on the input data, for example, determining the number or the amount of input data the data provider is allowed to do inference for the given AI model. Furthermore, at step 116, the method 100 includes sending the first token of the input data from the AI model provider to the computing device. After the generation of the first token of the input data as the cryptographic commitment on the MAC by the AI model provider, the AI model sends the generated first token of the input data to the computing device. As a result, the transmission of the first token for the input data serves as a unique identifier to verify that the input data received by the computing device is from the authorized data provider and therefore, enhances the overall data security and the data integrity.

Furthermore, at step 118, the method 100 includes decrypting, by the computing device, the encrypted input data and verifying the MAC received from the data provider with the second shared secret key. The input data, which is encrypted by the data provider, is received by the computing device. After that, the encrypted input data is decrypted by using the second shared secret key. Thereafter, the MAC received from the data provider is verified by the computing device to ensure that the decrypted input data is not tampered with and is received from the authorized data provider.

Furthermore, at step 120, the method 100 includes calculating, by the computing device, a second token of the input data for the AI model using the first shared secret key and the second shared secret key. In an implementation, the computing device is configured to calculate the second token of the input data using the shared keys, such as the first shared secret key and the second shared secret key to check if the second token matches the first token (received from the AI model provider) or not. As a result, the calculation of the second token of the input data for the AI model using the first shared secret key and the second shared secret key enhances the data security and data integrity by ensuring that the input data is received from the authorized source (i.e., the authorized data provider).

Furthermore, at step 122, the method 100 includes using, by the computing device, the decrypted input data on the AI model to obtain an inference result, if the second token of the input data for the AI model is identical to the first token of the input data received from the AI model provider or setting null data as the inference result otherwise. The inference result is obtained by decrypting the input data received by the computing device from the data provider. Moreover, the inference result is obtained by using the first token and the second token of the input data received from the AI model provider. In an implementation, the second token of the input data for the AI model is identical to the first token of the input data received from the AI model provider. In such a case, the method 100 includes using the decrypted input data on the AI model to obtain an inference result, such as by the computing device. Alternately, if the second token of the input data for the AI model is not identical to the first token of the input data received from the AI model provider, then, in that case, the method 100 includes setting null data as the inference result. As a result, the method 100 is used for ensuring data security and the accuracy of the inference result.

In accordance with an embodiment, the method 100 further includes sending the first cryptographic hash of the AI model from the AI model provider to the data provider. Furthermore, the method 100 includes sending a second cryptographic hash of the AI model decrypted with the first shared secret key from the computing device to the data provider and instructing, by the data provider, the computing device to proceed with decrypting the encrypted input data, if the second cryptographic hash of the AI model is identical to the first cryptographic hash of the AI model. Firstly, the method 100 includes sending the first cryptographic hash of the AI model from the AI model provider to the data provider. Thereafter, the computing device sends the second cryptographic hash of the AI model decrypted with the first shared secret key to the data provider. After that, the data provider checks if the received second cryptographic hash is identical to the first cryptographic hash, which is received from the AI model provider. In an implementation, if the first cryptographic hash and the second cryptographic hash are identical to each other, then, in that case, the data provider is configured to send a signal to the computing device for proceeding further with the decryption of the received encrypted input data. The received first cryptographic hash of the AI model and the second cryptographic hash of the AI model decrypted are used to ensure that the computing device has received the authentic AI model. However, there could be multiple input data and AI model providers running on the same AI accelerator at the same time while having isolation between the corresponding AI models. Therefore, the use of cryptographic hashes (i.e., the first cryptographic hash and the second cryptographic hash) provides an extra layer of verification to guarantee that the AI model has not been tampered with during transit. As a result, the method 100 is used to allow the data provider to verify the authenticity of the AI model before allowing the decryption of the input data, ensuring data integrity and security.

Furthermore, at step 124, the method 100 includes sending the inference result encrypted with the second shared secret key from the computing device to the data provider. The computing device encrypts the inference result with the second shared secret key to ensure the safe transmission of the inference result between the computing device and the data provider. Moreover, upon receiving the encrypted inference result, the data provider can decrypt the inference result to train or run the inference workload without revealing any part of the input data to the AI model provider. As a result, the overall confidentiality of the input data is enhanced with enhanced data security, integrity, and reliability.

In accordance with an embodiment, the method 100 further includes performing a third key exchange to establish a third shared secret key between the computing device and a second data provider for providing a second input data to the AI model. The performing of the third key exchange in order to establish the third shared secret key between the computing device and the second data provider (e.g., another hospital or any other such organization) is used to provide a second input data (e.g., patient's data) to be used by the AI model. As a result, the method 100 is used to enhance overall data security and data integrity of the second input data with enhanced reliability. Furthermore, the method 100 includes sending the second input data encrypted with the third shared secret key from the second data provider to the computing device and sending a second message authentication code, MAC, of the second input data obtained with the third shared secret key by the second data provider to the computing device and the AI model provider. After that, the method 100 includes calculating, by the AI model provider, the first token of the second input data as a cryptographic commitment on the second MAC received from the second data provider using the first shared secret key, sending the first token of the second input data from the AI model provider to the computing device, and decrypting, by the computing device, the encrypted second input data and verifying the second MAC received from the second data provider with the third shared secret key. The second input data, which is encrypted by the second data provider, is received by the computing device. After that, the second encrypted input data is decrypted by using the second shared secret key. Thereafter, the second MAC received from the second data provider is verified by the computing device to ensure that the decrypted second input data is not tampered with and is received from the authorized second data provider. Furthermore, the method 100 includes calculating, by the computing device, a second token of the second input data for the AI model using the first shared secret key and the third shared secret key and using, by the computing device, the decrypted second input data on the AI model to obtain a second inference result, if the second token of the second input data for the AI model is identical to the first token of the second input data received from the AI model provider, or setting null data as the second inference result otherwise. Finally, the method 100 includes sending the second inference result encrypted with the third shared secret key from the computing device to the second data provider. The second inference result is obtained by decrypting the second input data received by the computing device from the second data provider. Moreover, the second inference result is obtained by using the first token and the second token of the second input data received from the AI model provider. The calculation of the second token of the input data for the AI model using the first shared secret key and the third shared secret key enhances the data security and data integrity by ensuring that the second input data is received from the authorized source (i.e., the authorized data provider).

In accordance with an embodiment, the method 100 includes sending a first cryptographic hash of the AI model from the AI model provider to the second data provider. Furthermore, the method 100 includes sending a second cryptographic hash of the AI model decrypted with the third shared secret key from the computing device to the second data provider, and instructing, by the second data provider, the computing device to proceed with decrypting the encrypted second input data, if the second cryptographic hash of the AI model is identical to the first cryptographic hash of the AI model. The first cryptographic hash and the second cryptographic hash are used to ensure that the computing device has received the authentic AI model. The use of cryptographic hashes (i.e., the first cryptographic hash and the second cryptographic hash) provides an extra layer of verification to guarantee that the AI model has not been tampered with during transit. As a result, the method 100 is used to allow the second data provider to verify the authenticity of the AI model before allowing the decryption of the second input data, ensuring data integrity and security.

In accordance with an embodiment, the method 100 includes performing a fourth key exchange to establish a fourth shared secret key between a second AI model provider and the computing device. Furthermore, the method 100 includes sending a second AI model encrypted with the fourth shared secret key from the second AI model provider to the computing device. Thereafter, the method 100 includes decrypting, by the computing device, the received encrypted second AI model with the fourth shared secret key. After that, the method 100 includes sending a message authentication code, MAC, of the input data obtained with the second shared secret key from the data provider to the second AI model provider and calculating, by the second AI model provider, a first token of the input data as a cryptographic commitment on the MAC received from the data provider using the fourth shared secret key. Furthermore, the method 100 includes sending the first token of the input data from the second AI model provider to the computing device and calculating, by the computing device, a second token of the input data for the second AI model using the fourth shared secret key and the second shared secret key and using, by the computing device, the decrypted input data on the second AI model to obtain a third inference result, if the second token of the input data for the second AI model is identical to the first token of the input data received from the second AI model provider, or setting null data as the third inference result otherwise, and sending the third inference result encrypted with the second shared secret key from the computing device to the data provider. The performance of the fourth key exchange enables a secure collaboration and flexibility in AI-related projects involving multiple AI models and data providers. Subsequently, the second AI model provider sends the second AI model encrypted with the fourth shared secret key to the computing device. Upon receiving the encrypted AI model, the computing device decrypts the received second AI model using the fourth shared secret key, ensuring the availability of the AI model for inference. Additionally, the data provider sends the MAC of the input data to the second AI model provider, enhancing data integrity and the second AI model provider calculates a first token of the input data as a cryptographic commitment on the MAC using the fourth shared secret key to ensure authenticity. The first token is then sent to the computing device, which calculates a second token of the input data using both the fourth shared secret key and the second shared secret key. By utilizing the decrypted input data with the second AI model, the computing device obtains a third inference result, which is only produced if the second token matches the first token, ensuring the accuracy and reliability of the inference process. Finally, the computing device sends the encrypted third inference result back to the data provider, maintaining the security and confidentiality of the outcome.

In accordance with an embodiment, the method 100 includes sending a first cryptographic hash of the second AI model from the second AI model provider to the data provider, sending a second cryptographic hash of the second AI model decrypted with the fourth shared secret key from the computing device to the data provider, and instructing, by the data provider, the computing device to proceed with decrypting the input data, if the second cryptographic hash of the second AI model is identical to the first cryptographic hash of the second AI model. Firstly, the second AI model provider sends the first cryptographic hash of the second AI model to the data provider, which serves as a unique identifier for the second AI model. Additionally, the computing device generates the second cryptographic hash of the second AI model, which is decrypted using the fourth shared secret key and sends the corresponding second cryptographic hash to the data provider. The data provider compares the first cryptographic hash and the second cryptographic hash. In an implementation, if the second cryptographic hash of the second AI model is identical to the first cryptographic hash, then, in that case, the data provider instructs the computing device to proceed with decrypting the input data, which ensures that only the authorized and unaltered version of the second AI model is used for decrypting the input data. In another implementation, if the second cryptographic hash of the second AI model is not identical to the first cryptographic hash, then, in that case, the data provider instructs the computing device not to proceed with decrypting the input data, which ensures that only the authorized and unaltered version of the second AI model is used for decrypting the input data. By employing the method 100, the integrity and authenticity of the second AI model are effectively verified before proceeding with the decryption process. Therefore, the method 100 provides a reliable and secure mechanism for ensuring that the input data is decrypted using the correct and unmodified AI model, thereby enhancing the overall security of the data transmission.

The method 100 is used for establishing a confidential AI infrastructure that includes the establishment of the key exchange (e.g., the first key exchange, the second key exchange, and the like) to ensure secure exchanges of encrypted AI models and data, thereby ensuring that the data remains protected during data transmission and data processing. This also reduces the risk of data breaches and unauthorized access. Furthermore, the method 100 is used to generate tokens that impose security properties on the data, determining the quantity of data the data provider is allowed to use for inference with the given confidential AI model. The data providers are allowed to share the input data with the computing device without revealing the data to the AI model provider. This preserves the data confidentiality of the data while enabling AI model inference. The method 100 includes verifying the integrity of the AI model, which ensures that the data has not been tampered during the data transmission that enhances the overall authenticity of the AI model. Moreover, the method 100 supports collaboration among multiple parties, including data providers and model providers, enabling secure data sharing and the utilization of AI models, fostering cooperation in AI-related projects, and making the AI model adaptable to a variety of collaborative platforms. The inclusion of AI accelerators in the computing device enhances the efficiency and the computation speed of AI model inference, making the computing device suitable for real-time applications. Additionally, the method 100 can be applied to large language models (LLMs) where queries from multiple data providers are merged or where a single data provider runs the inference workloads on multiple models simultaneously. Hence, the method 100 is used for establishing a secure and confidential environment for AI-related operations, facilitating collaboration while ensuring data security, reliability, model integrity, and efficiency in AI model deployment.

The steps 102 to 124 are only illustrative, and other alternatives can also be provided where one or more steps are added, one or more steps are removed, or one or more steps are provided in a different sequence without departing from the scope of the claims herein.

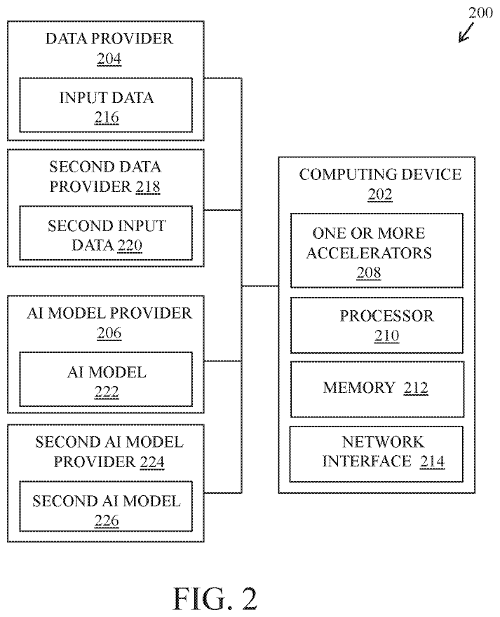

FIG. 2 is a block diagram of a computing device for deploying an artificial intelligence, AI, model, in accordance with an embodiment of the present disclosure. FIG. 2 is described in conjunction with elements from FIG. 1. With reference to FIG. 2, there is shown a block diagram 200 that depicts a computing device 202, a data provider 204, and an AI model provider 206. The computing device 202 is configured to execute the method 100 of FIG. 1.

The computing device 202 is configured for deploying the AI model. Examples of the computing device 202 may include but are not limited to, a computer, a personal digital assistant, a portable computing device, or an electronic device. The computing device 202 includes one or more AI accelerators 208, a processor 210, a memory 212, and a network interface 214.

The processor 210 is configured to execute instructions stored in the memory 212. Examples of the processor 210 may include, but are not limited to an integrated circuit, a co-processor, a microprocessor, a microcontroller, a complex instruction set computing (CISC) processor, an application-specific integrated circuit (ASIC) processor, a reduced instruction set (RISC) processor, a very long instruction word (VLIW) processor, a central processing unit (CPU), a state machine, a data processing unit, and other processors or circuits. Moreover, the processor 210 may refer to one or more individual processors, processing devices, or a processing unit that is part of a machine.

The memory 212 is configured to store machine code and/or instructions executable by the processor 210. Examples of implementation of the memory 212 may include, but are not limited to, an Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer-readable storage medium, and/or CPU cache memory.

The network interface 214 may include hardware or software that is configured to establish communication among the processor 210, the memory 212, and the one or more AI accelerators 208. Examples of the network interface 214 may include but are not limited to, a computer port, a network socket, a network interface controller (NIC), and any other network interface device.

There is provided the computing device 202 for deploying an AI model 222. The computing device 202 is capable of accelerating neural network computation, a cloud computing software stack in which the AI model providers, and the data provider 204 (such as a hospital with patient's data, or a private individual) provide the encrypted AI model and the data so that the data provider 204 can run inference workload with an input data 216 on the AI model 222. In accordance with an embodiment, the computing device 202 includes the one or more AI accelerators 208. In an example, the computing device 202 includes one AI accelerator. In another example, the computing device 202 includes more than one AI accelerator. The one or more AI accelerators 208 refers to an AI accelerator that is designed to enhance the speed and efficiency of the AI computations making them suitable for real-time applications and enhancing the overall performance of AI systems. As a result, the data provider 204 establishes the confidential AI infrastructure without revealing the actual data to ensure safe and secure data transmission and data processing.

The computing device 202 is configured to participate in a first key exchange to establish a first shared secret key between the computing device 202 and the AI model provider 206. The first shared secret key is a cryptographic key, such as a security key, private key, and the like, that is exchanged between the AI provider and the computing device 202 for deploying the AI model. Moreover, the AI model provider 206 refers to an entity or organization that creates, develops, or supplies AI models (e.g., the AI model 222) that are the core components of various AI applications and systems. Furthermore, the first shared key is known only to the AI model provider 206 and the computing device. In an implementation, the first shared secret key exchange starts with an exchange of public keys of each of the parties (i.e., the AI model provider 206 and the computing device), such as by using public key crypto and deriving a key for a symmetric key (e.g., AES-GCM) encryption. As a result, the first key exchange is used to establish a secure channel between the AI model provider 206 and the computing device 202 configured for deploying the AI model 222 to allow safe and secure communication with reduced risk of data breach and unauthorized access.

Furthermore, the computing device 202 is configured to participate in a second key exchange to establish a second shared secret key between the computing device 202 and the data provider 204 for receiving the input data 216 to the AI model. The second shared secret key refers to another cryptographic key, such as a security key, private key, and the like, that is exchanged between the computing device 202 and the AI provider for providing the input data 216 to the AI model as described in detail in FIG. 1A and FIG. 1B.

Furthermore, the computing device 202 is configured for receiving the AI model encrypted with the first shared secret key from the AI model provider 206. After the establishment of the secure communication channel, the AI model provider 206 sends the AI model encrypted with the first shared secret key to the computing device. The encryption of the AI model refers to a process for converting a plain readable AI model into a coded form that can be accessed through the first shared secret key only. Moreover, the encryption of the AI model ensures safety, and security, and eliminates the risk of potential threats during the transmission of the AI model from the AI model provider 206 to the computing device. As a result, the confidentiality, integrity, and reliability of the AI model are maintained.

Furthermore, the computing device 202 is configured for decrypting the received encrypted AI model with the first shared secret key. Firstly, the data provider 204 is configured to encrypt the input data 216 to protect the data from unauthorized access. The encryption of the input data 216 refers to the conversion of the input data 216 into a coded form that cannot be read and accessed easily as described in detail in FIG. 1A and FIG. 1B. After that, the data provider 204 sends the encrypted input data (e.g., a file or any other data, such as image, multi-media, and the like) to the computing device 202 along with the second shared secret key. Moreover, the second shared key is used for further decrypting the input data 216. As a result, the encryption of the input data 216 ensures that the input data 216 remains confidential and secure during the data transfer between the data provider 204 and the computing device 202.

Furthermore, the computing device 202 is configured for receiving the input data 216 encrypted with the second shared secret key and a message authentication code, MAC, of the input data 216 obtained with the second shared secret key from the data provider. Moreover, the data provider 204 sends the MAC of the input data 216 obtained with the second shared secret key to the AI model provider 206. The MAC is derived from the input data 216 and serves as a one-way commitment to the input data 216. The data provider 204 sends the MAC of the input data 216 to the AI model provider 206 and the computing device 202, as described in detail in FIG. 1A and FIG. 1B. As a result, the creation of the MAC based on the input data 216 and the second shared secret key is used to ensure data authenticity and data integrity during the data transmission.

Furthermore, the computing device 202 is configured for receiving the first token of the input data 216 from the AI model provider 206. Moreover, the first token of the input data 216 is calculated by the AI model provider 206 as a cryptographic commitment on the MAC received from the data provider 204 using the first shared secret key. In other words, the AI model 222 calculates the first token of the input data 216 by calculating a cryptographic commitment on the MAC received from the data provider 204 using the first shared secret key. Moreover, such calculation by the AI model provider 206 is used to impose security properties on the input data 216, for example, for determining the number or the amount of the input data 216 the data provider 204 is allowed to do inference for the AI model 222. As a result, the transmission of the first token for the input data 216 serves as a unique identifier to verify that the input data 216 received by the computing device 202 is from the authorized data provider to enhance the overall data security and the data integrity.

Furthermore, the computing device 202 is configured for decrypting the encrypted input data and verifying the MAC received from the data provider 204 with the second shared secret key. The input data 216, which is encrypted by the data provider 204, is received by the computing device. After that, the encrypted input data is decrypted by using the second shared secret key. Thereafter, the MAC received from the data provider 204 is verified by the computing device 202 to ensure that the decrypted input data is not tampered with and is received from the authorized data provider. Furthermore, the computing device 202 is configured for calculating a second token of the input data 216 for the AI model using the first shared secret key and the second shared secret key. As a result, the calculation of the second token of the input data 216 for the AI model using the first shared secret key and the second shared secret key enhances the data security and data integrity by ensuring that the input data 216 is received from the authorized source (i.e., the authorized data provider). Furthermore, the computing device 202 is configured for using the decrypted input data on the AI model to obtain an inference result, if the second token of the input data 216 for the AI model is identical to the first token of the input data 216 received from the AI model provider 206 or setting null data as the inference result otherwise. The inference result is obtained by decrypting the input data 216 received by the computing device 202 from the data provider. Moreover, the inference result is obtained by using the first token and the second token of the input data 216 received from the AI model provider 206. In an implementation, the second token of the input data 216 for the AI model is identical to the first token of the input data 216 received from the AI model provider 206. In such a case, the computing device 202 is configured to use the decrypted input data on the AI model to obtain an inference result, such as by the computing device 202. Alternately, if the second token of the input data 216 for the AI model is not identical to the first token of the input data 216 received from the AI model provider 206, then, in that case, the computing device 202 is configured for setting null data as the inference result. As a result, the computing device 202 is configured to ensure data security and the accuracy of the inference result.

In accordance with an embodiment, the computing device 202 is further configured for sending a second cryptographic hash of the AI model decrypted with the first shared secret key to the data provider. Moreover, the data provider 204 receives the first cryptographic hash of the AI model 222 from the AI model provider 206 and decrypts the encrypted input data with the second shared secret key only upon receiving instructions from the data provider 204. Moreover, the instructions are indicative that the second cryptographic hash of the AI model is identical to the first cryptographic hash of the AI model. The use of cryptographic hashes (i.e., the first cryptographic hash and the second cryptographic hash) provides an extra layer of verification to guarantee that the AI model 222 has not been tampered during the data transmission. As a result, the computing device 202 is used to allow the data provider to verify the authenticity of the AI model 222 before allowing the decryption of the input data 216, ensuring data integrity and security.

Furthermore, the computing device 202 is configured for sending the inference result encrypted with the second shared secret key to the data provider. The computing device 202 encrypts the inference result with the second shared secret key to ensure the safe transmission of the inference result between the computing device 202 and the data provider. Moreover, upon receiving the encrypted inference result, the data provider 204 can decrypt the inference result to train or run the inference workload without revealing any part of the input data 216 to the AI model provider 206. As a result, the overall confidentiality of the input data 216 is improved with enhanced data security, integrity, and reliability.

In accordance with an embodiment, the computing device is further configured for participating in a third key exchange to establish a third shared secret key between the computing device 202 and a second data provider 218 for receiving a second input data 220 to the AI model, receiving the second input data 220 encrypted with the third shared secret key and a second message authentication code, MAC, of the second input data 220 obtained with the third shared secret key from the second data provider. Moreover, the second data provider 218 sends the second MAC of the second input data 220 obtained with the third shared secret key to the AI model provider 206. Furthermore, the computing device 202 is configured for receiving a first token of the second input data 220 from the AI model provider 206. Moreover, the first token of the second input data 220 is calculated by the AI model provider 206 as a cryptographic commitment on the second MAC received from the second data provider 218 using the first shared secret key. Furthermore, the computing device 202 is configured for decrypting the encrypted second input data and verifying the second MAC received from the second data provider 218 with the third shared secret key and calculating a second token of the second input data 220 for the AI model using the first shared secret key and the third shared secret key, using the decrypted second input data on the AI model to obtain a second inference result if the second token of the second input data 220 for the AI model is identical to the first token of the second input data 220 received from the AI model provider 206, or setting null data as the second inference result otherwise. Finally, the computing device 202 is configured for sending the second inference result encrypted with the third shared secret key to the second data provider. The second inference result is obtained by decrypting the second input data received by the computing device 202 from the second data provider 218 as described in detail in FIG. 1A and FIG. 1B. Moreover, the second inference result is obtained by using the first token and the second token of the second input data 220 received from the AI model provider 206.

In accordance with an embodiment, the computing device 202 is further configured for sending a second cryptographic hash of the AI model decrypted with the third shared secret key to the second data provider 218 and the second data provider 218 receives a first cryptographic hash of the AI model from the AI model provider 206. Furthermore, the computing device 202 is configured for encrypting the encrypted second input data only upon receiving instructions from the second data provider 218. Moreover, the instructions are indicative that the second cryptographic hash of the AI model 222 is identical to the first cryptographic hash of the AI model 222. The first cryptographic hash and the second cryptographic hash decrypted are used to ensure that the computing device 202 has received the authentic AI model. The use of cryptographic hashes (i.e., the first cryptographic hash and the second cryptographic hash) provides an extra layer of verification to guarantee that the AI model 222 has not been tampered with during transit. As a result, the computing device 202 is used to allow the second data provider 218 to verify the authenticity of the AI model 222 before allowing the decryption of the second input data 220, ensuring data integrity and security.

In accordance with an embodiment, the computing device 202 is further configured for participating in a fourth key exchange to establish a fourth shared secret key between the computing device 202 and a second AI model provider 224, receiving a second AI model 226 encrypted with the fourth shared secret key from the second AI model provider 224, and decrypting the received encrypted second AI model with the fourth shared secret key. Furthermore, the computing device 202 is configured for receiving the first token of the input data 216 from the second AI model provider 224. The first token of the input data 216 is calculated by the second AI model provider 224 as a cryptographic commitment on a message authentication code, MAC, of the input data 216 obtained by the data provider 204 with the second shared secret key and received by the second AI model 226 from the data provider. Moreover, the cryptographic commitment is obtained by the second AI model provider 224 using the fourth shared secret key. After that, the computing device 202 is configured for decrypting the encrypted input data and verifying the MAC received from the data provider 204 with the second shared secret key, calculating a second token of the input data 216 for the second AI model using the fourth shared secret key and the second shared secret key, using the decrypted input data on the second AI model to obtain a third inference result, if the second token of the input data 216 for the second AI model 226 is identical to the first token of the input data 216 received from the second AI model provider 224, or setting null data as the third inference result otherwise, and sending the third inference result encrypted with the second shared secret key to the data provider 204. By utilizing the decrypted input data with the second AI model 226, the computing device 202 obtains a third inference result, which is only produced if the second token matches the first token, ensuring the accuracy and reliability of the inference process. Finally, the computing device 202 sends the encrypted third inference result back to the data provider, maintaining the security and confidentiality of the outcome.

In accordance with an embodiment, the computing device 202 is further configured for sending a second cryptographic hash of the second AI model 226 decrypted with the fourth shared secret key to the data provider. The data provider 204 receives the first cryptographic hash of the second AI model from the second AI model provider 224 and decrypts the encrypted input data only upon receiving instructions from the data provider 204. Moreover, the instructions are indicative that the second cryptographic hash of the second AI model 226 is identical to the first cryptographic hash of the second AI model 226. As a result, the computing device 202 is configured to enhance the integrity and authenticity of the second AI model 226 and is effectively verified before proceeding with the decryption process. Therefore, the computing device 202 is configured to provide a reliable and secure mechanism for ensuring that the input data 216 is decrypted using the correct and unmodified AI model, thereby enhancing the overall security of the data transmission.

The computing device 202 is configured for establishing a confidential AI infrastructure that includes the establishment of the key exchange (e.g., the first key exchange, the second key exchange, and the like) to ensure secure exchanges of encrypted AI models and data, thereby ensuring that the data remains protected during data transmission and data processing. This also reduces the risk of data breaches and unauthorized access. Furthermore, the computing device 202 is used to generate tokens that impose security properties on the data, determining the quantity of data the data provider 204 is allowed to use for inference with a given confidential AI model. The data providers are allowed to share the input data 216 with the computing device 202 without revealing the data to the AI model provider 206. This preserves the data confidentiality of the data while enabling AI model inference. The computing device 202 is configured to verify the integrity of the AI model, which ensures that the data has not been tampered with during transmission and enhances the overall authenticity of the AI model. Moreover, the computing device 202 is configured to support collaboration among multiple parties, including data providers and model providers, enabling secure data sharing and the utilization of AI models, fostering cooperation in AI-related projects, and making the AI model adaptable to a variety of collaborative platforms. The inclusion of AI accelerators in the computing device 202 enhances the efficiency and the computation speed of AI model inference, making the computing device 202 suitable for real-time applications. Additionally, the computing device 202 can be used for large language models (LLMs) where queries from multiple data providers are merged or where a single data provider (e.g., the data provider 204) runs the inference workloads on multiple models simultaneously. Hence, the computing device 202 is configured for establishing a secure and confidential environment for AI-related operations, facilitating collaboration while ensuring data security, reliability, model integrity, and efficiency in AI model deployment.

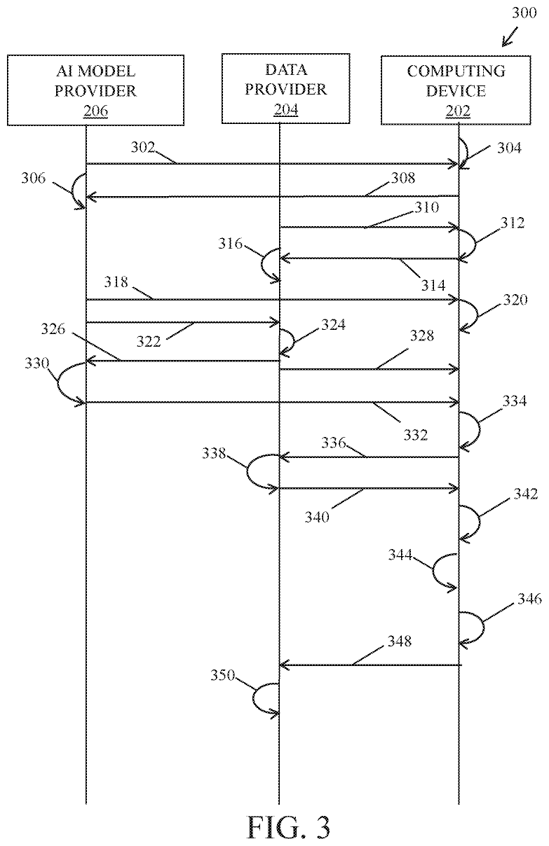

FIG. 3 is a sequence diagram that depicts an execution of establishing a confidential artificial intelligence infrastructure, in accordance with an embodiment of the present disclosure. FIG. 3 is described in conjunction with elements from FIGS. 1A, 1, and 2. With reference to FIG. 3, there is shown an illustration 300 that depicts the execution of establishing a confidential artificial intelligence, AI, infrastructure. The illustration 300 includes operations 302 to 350.

At operation 302 and at operation 308, the computing device 202 is configured to participate in a first key exchange (i.e., PK_{M} and PK_{H}) to establish a first shared secret key (i.e., K_{M}←DHKEK_{H},PK_{M}) at operation 304, and K_{M}←DHKE (SK_{M},PK_{H}) at operation 306) between the AI model provider 206 and the computing device 202 configured for deploying an AI model. Furthermore, at operation 310 and operation 314, the computing device 202 is configured to participate in a second key exchange (i.e., PK_{D}) to establish a second shared secret key (i.e., K_{D}←DHKE (SK_{H}, PK_{D}), such as at operation 312 and K_{D}←DHKE (SK_{D}, PK_{D}) at operation 316) between the computing device 202 and the data provider 204 for receiving an input data to the AI model. The first key exchange and the second key exchange are used to ensure a separate transmission of data through secure channels between the AI model provider 206, the computing device 202, and the data provider 204.

At operation 318, the AI model provider 206 is configured to send the AI model (i.e., an AI model Mₐ) encrypted (e.g., C_{M}←Enc_{K}_{_{M}} (Mₐ)) with the first shared secret key to the computing device 202, such as by using the shared key between the AI model provider 206 and the computing device 202. For example, the data provider 204 encrypts the input data (I₁) with AES-GCM and K_{d} to produce C₁←E_{K}_{_{D}} (I₁), and MAC Tag₁←MAC_{K}_{_{D}} (I₁). At operation 320, the computing device 202 is configured to decrypt, verify, and deploy the received encrypted AI model with the first shared secret key. Furthermore, at operation 322, the AI model provider 206 sends a cryptographic hash of the model to the data provider 204. The data provider 204, at operation 324, registers the input data to be used for inference input by sending the cryptographic commitment to the AI model provider 206 by calculating a MAC (i.e., T₁←MAC_{K}_{_{M}} (C₁)) using the shared key between the data provider 204 and the computing device 202, such as at operation 326. For example, the data provider 204 sends the input data (I₁) to ensure that the accuracy of the input data (i.e., Iₓ, ∀x>0) to be fed to the AI Model (M₁) and the data provider 204 sends the cryptographic commitment (C₁, Tag₁,) to the AI model provider 206. After that, the data provider 204 sends the encrypted data and the MAC of the input data to the computing device 202 using the shared key between the data provider 204 and the computing device 202, such as at operation 328.

Furthermore, at operation 330, the AI model provider 206 is configured to calculate a token of the input data by calculating a cryptographic commitment on the MAC from the data provider 204 using the shared key between the AI model provider 206 and the computing device 202 and further send it to the computing device 202, such as at operation 332. After that, at operation 334, the computing device 202 is configured to decrypt the encrypted input data and verify the MAC received from the data provider 204 with the second shared secret key. At operation 336, the computing device 202 is configured to send the cryptographic hash of the decrypted AI model to the data provider 204. The data provider 204, at operation 338, checks if the hash received from the computing device 202 is same as the hash received from the AI model provider 206. If there is a match, the data provider 204 sends a signal to the computing device 202 to proceed with the model inference with the secret input data, such as at operation 340.

Furthermore, at operation 342, the computing device 202 is configured to feed the AI model (Mₐ) with {C₁, T₁, K_{D}, K_{M}} the shared secret key, generated tokens, and the produced cipher text. Thereafter, at operation 344, the computing device is configured to decrypt the encrypted input data (C₁) by using the AI model (Mₐ) to obtain the inference result and compute the the second token of the input data for the AI model using the first shared secret key and the second shared secret key and further use the decrypted input data on the AI model to obtain an inference result (i.e.,

$${T}_{1}^{′}$$

from I₁ using K_{D} and K_{M},

$${T}_{1}^{′} ← M A {C}_{{K}_{M}} ( {C}_{1} ) ) .$$

Moreover, if the second token of the input data for the AI model is identical to the first token of the input data received from the AI model provider 206 or setting null data as the inference result otherwise. For example, the AI model (Mₐ) verifies that

$${T}_{1}^{′} == {T}_{1} ,$$

if the verification fails then the AI model (Mₐ) sets the inference result as null (e.g., I₁=[0, 0, 0, . . . , 0]). Furthermore, at operation 346, the computing device 202, such as through the AI model (Mₐ) is configured to execute on the inference result and produces an output (i.e., O₁). Furthermore, the computing device 202, such as by the AI model (Mₐ) encrypts the generated output (O₁) with the shared secret key (K_{d}) to produce the encrypted data (C₁′), which is further sent to the data provider 204 at operation 348. Finally, at operation 350, the data provider 204 decrypts the received encrypted data by using the shared secret key (e.g., the key exchanged between the data provider 204 and the computing device 202).

As a result, the AI model provider 206 is configured to send the encrypted AI model that can be decrypted on the computing device 202 due to which the possibility of tampering with the AI model is eliminated. Furthermore, the data provider 204 is configured to send MAC of the input data to the AI model provider 206. Moreover, the MAC is a one-way commitment of the input data due to which the data provider 204 does not reveal the data to the AI model provider 206. In addition, the cryptographic hash of the confidential AI model ensures that the computing device 202 has loaded the correct AI model so that multiple input data and AI model providers can run on the same AI accelerator at the same time while having isolation between them in order to improve the overall data security and integrity for reliable and effective network communication.

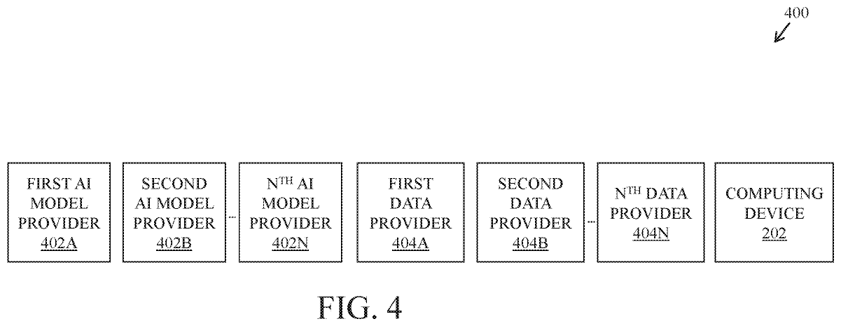

FIG. 4 depicts an exemplary illustration that depicts a plurality of artificial intelligence model providers and a plurality of data providers that are connected with a computing device to establish a confidential AI infrastructure, in accordance with an embodiment of the present disclosure. FIG. 4 is described in conjunction with elements from FIGS. 1A, 1, 2, and 3. With reference to FIG. 4, there is shown an exemplary illustration 400 that depicts the plurality of artificial intelligence model providers and the plurality of data providers connected with the computing device 202 to establish a confidential AI infrastructure.

In an exemplary scenario, the plurality of AI model providers includes, a first AI model provider 402A, a second AI model provider 402B, up to the nth AI model provider 402N and the plurality of data providers includes a first data provider 404A, a second data provider 404B, up to Nth data provider 404N. The computing device 202 is configured to support any mapping between the plurality of AI model providers and the plurality of data providers. In an example, the first data provider 404A is mapped with the plurality of AI model providers, such as the first AI model provider 402A, the second AI model provider 402B, up to the Nth AI model provider 402N. In an implementation, the first data provider 404A is configured to perform a first key exchange to establish a first shared secret key (e.g., Pk_{M1}, Sk_{M1}) between the first AI model provider 402A, the second AI model provider 402B (e.g., Pk_{M2}, Sk_{M2}), up to the Nth AI model provider 402N (e.g., Pk_{Mn}, Sk_{Mn}) and the computing device 202 configured for deploying the AI model. In another example, the plurality of data providers, such as the first data provider 404A, the second data provider 404B, up to the Nth data provider 404N are mapped with the first AI model provider 402A. In yet another example, each of the plurality of AI model providers is mapped with each of the plurality of data providers, such as the first data provider 404A is mapped with the first AI model provider 402A, the second AI model provider 402B, up to the Nth AI model provider and the first AI model provider 402A is mapped with the first data provider 404A, the second AI model provider 402B, up to the Nth AI model provider 402N, such as by performing the shared secret key exchange (e.g., (Pk_{D1}, Sk_{D1}), (Pk_{D2}, Sk_{D2}), (Pk_{Dn}, Sk_{Dn})). As a result, the computing device 202 is configured to provide an efficient, flexible deployment of the confidential AI infrastructure to support multiple possibilities of mapping between the plurality of AI model providers, the plurality of data providers, and the computing device 202 with enhanced overall data security and data integrity.

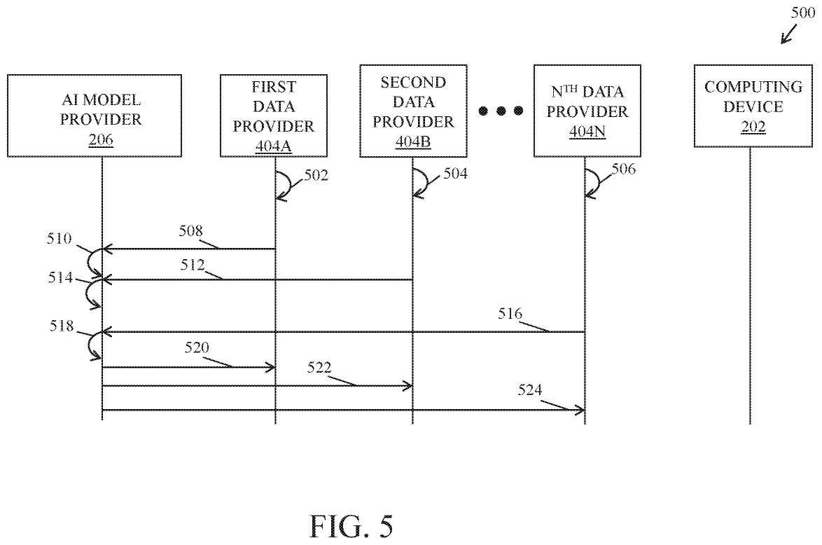

FIG. 5 is a sequence diagram that depicts a token generation for a plurality of data providers, in accordance with an embodiment of the present disclosure. FIG. 5 is described in conjunction with elements from FIGS. 1A, 1B, 2, 3, and 4. With reference to FIG. 5, there is shown an illustration 500 that depicts the token generation for a plurality of data providers. The illustration 500 includes operations 502 to 524.

In an implementation scenario, the plurality of data providers, such as the first data provider 404A, the second data provider 404B, up to the Nth data provider 404N are configured to register the input data to be used for inference input by sending the cryptographic commitment to the AI model provider 206 and calculating a message authentication code (MAC) using the shared key between the corresponding data provider and the computing device 202. In an example, at operation 502, the first data provider 404A is configured to register the input data (e.g., C₁-Enc_{K}_{_{D}} (I₁) and Tag₁←MAC_{K}_{_{D}} (I₁) that can be used for inference input by sending the cryptographic commitment, for example, Tag₁ to the AI model provider 206, such as at operation 508 and calculating the MAC using the shared key between the first data provider 404A and the computing device 202.

In another example, at operation 504, the second data provider 404B is configured to register the input data, for example, C₂←Enc_{K}_{_{D}} (I₂) to be used for inference input by sending the cryptographic commitment, for example, Tag₂ to the AI model provider 206, such as at operation 512 and calculating the MAC using the shared key between the second data provider 404B and computing device 202. In yet another example, at operation 506, the Nth data provider 404N is configured to register the input data, (i.e., depicted as Cₙ←Enc_{K}_{_{D}} (Iₙ) and Tagₙ←MAC_{K}_{_{D}} (Iₙ) to be used for inference input by sending the cryptographic commitment, (i.e., depicted as, Tag₂) to the AI model provider 206, such as at operation 516 and calculating the MAC using the shared key between the Nth data provider 404N and the computing device 202. Furthermore, the AI model provider 206 is configured to calculate a token, such as a first token (i.e., at operation 510), a second token (i.e., at operation 514), and an nth token (i.e., at operation 518) of the input data by calculating the cryptographic commitment on the MAC received from the plurality of data providers, such as the first data provider 404A, the second data provider 404B, up to the Nth data provider 404N using the shared key between the AI model provider 206 and the computing device 202. Finally, at operation 520, the generated first token, (i.e., depicted as T₁) is sent to the first data provider 404A. Similarly, at operation 522, the generated second token (can be depicted as T₂) is sent to the second data provider 404B and at operation 524, the generated Nth token, (i.e., depicted as Tₙ) is sent to the Nth data provider 404N. Moreover, the token generation for the plurality of data providers can be used in large language models to provide input-dependent token generation without revealing the input data to the AI model provider. As a result, the token generation is used to impose security properties on the input data in order to determine the amount of the input data from the plurality of data providers, such as the first data provider 404A, the second data provider 404B, up to the Nth data provider 404N are allowed to do inference for the confidential AI model.

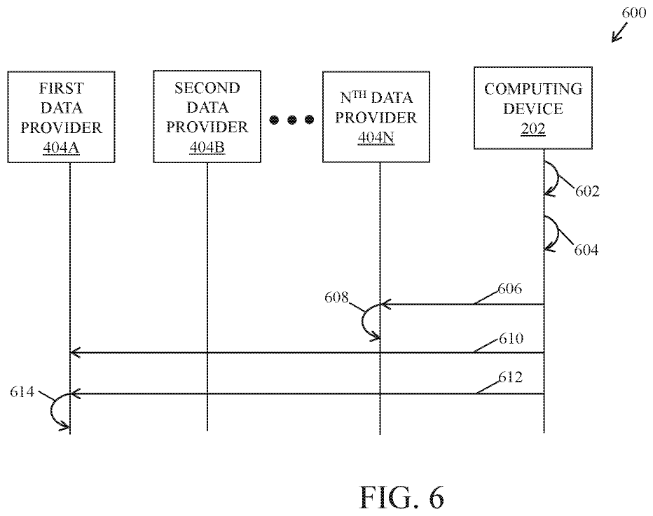

FIG. 6 is a sequence diagram that depicts a model execution for the plurality of data providers, in accordance with an embodiment of the present disclosure. FIG. 6 is described in conjunction with elements from FIGS. 1A, 1i, 2, 3, 4, and 5. With reference to FIG. 6, there is shown an illustration 600 that depicts the model execution for the plurality of data providers. The illustration 600 includes operations 602 to 614.

At operation 602, the computing device 202 is configured to feed the AI model (i.e., the AI model Mₐ) with cryptographic hashes from the first cryptographic hash (C₁) to nth cryptographic hash (Cₙ) (can be depicted as C_{{1 . . . n}}), tokens from the first token (T₁) to nth token (Tₙ) (can be depicted as T_{{1 . . . n}}), secret keys from the AI model provider to the computing device 202, such as from a first secret key K_{D}_{₁} to the nth secret key K_{D}_{ₙ} (can be depicted as (K_{D}_{_{{1 . . . n}}}) and a secret key transmitted from the data provider 204 to the computing device 202. Thereafter, at operation 604, the computing device is configured to decrypt the encrypted input data (C₁) by using the AI model (Mₐ) to obtain the inference result and compute the the second token of the input data for the AI model using the first shared secret key and the second shared secret key and further use the decrypted input data on the AI model to obtain an inference result (i.e.,

$${T}_{1}^{′}$$

from I₁ using K_{D} and K_{M},

$${T}_{1}^{′} ← MA {C}_{{K}_{M}} ( {C}_{1} ) ) .$$

Moreover, if the second token of the input data for the AI model is identical to the first token of the input data received from the AI model provider 206 or setting null data as the inference result otherwise. For example, the AI model (Mₐ) verifies that

$${T}_{1}^{′} == {T}_{1} ,$$

if the verification fails then the AI model (Mₐ) sets the inference result as null (e.g., I₁=[0, 0, 0, . . . , 0]). Furthermore, the computing device 202, such as through the AI model (Mₐ) is configured to execute on the inference result with the input data (I₁) and produces an output (i.e., O₁). Furthermore, the computing device 202, such as the AI model (Mₐ) encrypts the generated output (Oₙ) with the shared secret key (K_{d}) to produce the encrypted data (C₁′), which is further sent to the Nth data provider 404N, such as at operation 606. Finally, at operation 608, the Nth data provider 404N decrypts the received encrypted data by using the shared secret key (e.g., the key exchanged between the Nth data provider 404N and the computing device 202). Similarly, at operation 610, the computing device 202 is configured to send the generated output (O₂) with the shared secret key (K_{d}) to produce the second encrypted data (C₂′), which is further sent to the Second data provider 404B to send the generated output (01) with the shared secret key (K_{d}) to produce the second encrypted data (C₁′), which is further sent to the first data provider 404A, such as at operation 612. Furthermore, at operation 614, the first data provider 404A decrypts the received encrypted data by using the shared secret key (e.g., the key exchanged between the first data provider 404A and the computing device 202). As a result, the computing device 202 is configured to execute the AI model with the input data if the correct tokens (i.e., the first token, the second token, up to the Nth token) are generated by the AI model provider 206 in order to send the encrypted result back to the corresponding data providers, such as the first data provider 404A, the second data provider 404B, up to the Nth data provider 404N.

Modifications to embodiments of the present disclosure described in the foregoing are possible without departing from the scope of the present disclosure as defined by the accompanying claims. Expressions such as “including”, “comprising”, “incorporating”, “have”, “is” used to describe, and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the invention, which are, for brevity, described in the context of a single embodiment, may also be provided separately or in any suitable combination or as suitable in any other described embodiment of the disclosure.

1. A method (100) of establishing confidential artificial intelligence, AI, infrastructure, the method (100) comprising:
performing a first key exchange to establish a first shared secret key between an AI model provider (206) and a computing device (202) configured for deploying an AI model (222),
performing a second key exchange to establish a second shared secret key between the computing device (202) and a data provider (204) for providing an input data (216) to the AI model (222),
sending the AI model (222) encrypted with the first shared secret key from the AI model provider (206) to the computing device (202),
decrypting, by the computing device (202), the received encrypted AI model with the first shared secret key,
sending the input data (216) encrypted with the second shared secret key from the data provider (204) to the computing device (202),
sending a message authentication code, MAC, of the input data (216) obtained with the second shared secret key from the data provider (204) to the computing device (202) and the AI model provider (206),
calculating, by the AI model provider (206), a first token of the input data (216) as a cryptographic commitment on the MAC received from the data provider (204) using the first shared secret key,
sending the first token of the input data (216) from the AI model provider (206) to the computing device (202),
decrypting, by the computing device (202), the encrypted input data (216) and verifying the MAC received from the data provider (204) with the second shared secret key,
calculating, by the computing device (202), a second token of the input data (216) for the AI model (222) using the first shared secret key and the second shared secret key,
using, by the computing device (202), the decrypted input data (216) on the AI model (222) to obtain an inference result, if the second token of the input data (216) for the AI model (222) is identical to the first token of the input data (216) received from the AI model provider (206), or setting null data as the inference result otherwise, and
sending the inference result encrypted with the second shared secret key from the computing device (202) to the data provider (204).

2. The method (100) of claim 1, further comprising:
sending a first cryptographic hash of the AI model (222) from the AI model provider (206) to the data provider (204),
sending a second cryptographic hash of the AI model (222) decrypted with the first shared secret key from the computing device (202) to the data provider (204), and
instructing, by the data provider (204), the computing device (202) to proceed with decrypting the encrypted input data (216), if the second cryptographic hash of the AI model (222) is identical to the first cryptographic hash of the AI model (222).

3. The method (100) of claim 1, further comprising:
performing a third key exchange to establish a third shared secret key between the computing device (202) and a second data provider (218) for providing a second input data (220) to the AI model (222),
sending the second input data (220) encrypted with the third shared secret key from the second data provider (218) to the computing device (202),
sending a second message authentication code, MAC, of the second input data (220) obtained with the third shared secret key by the second data provider (218) to the computing device (202) and the AI model provider (206),
calculating, by the AI model provider (206), a first token of the second input data (220) as a cryptographic commitment on the second MAC received from the second data provider (218) using the first shared secret key,
sending the first token of the second input data (220) from the AI model provider (206) to the computing device (202),
decrypting, by the computing device (202), the encrypted second input data (220) and verifying the second MAC received from the second data provider (218) with the third shared secret key,
calculating, by the computing device (202), a second token of the second input data (220) for the AI model (222) using the first shared secret key and the third shared secret key,
using, by the computing device (202), the decrypted second input data (220) on the AI model (222) to obtain a second inference result, if the second token of the second input data (220) for the AI model (222) is identical to the first token of the second input data (220) received from the AI model provider (206), or setting null data as the second inference result otherwise, and
sending the second inference result encrypted with the third shared secret key from the computing device (202) to the second data provider (218).

4. The method (100) of claim 3, further comprising:
sending a first cryptographic hash of the AI model (222) from the AI model provider (206) to the second data provider (218),
sending a second cryptographic hash of the AI model (222) decrypted with the third shared secret key from the computing device (202) to the second data provider (218), and
instructing, by the second data provider (218), the computing device (202) to proceed with decrypting the encrypted second input data, if the second cryptographic hash of the AI model (222) is identical to the first cryptographic hash of the AI model (222).

5. The method (100) of claim 1, further comprising:
performing a fourth key exchange to establish a fourth shared secret key between a second AI model provider (224) and the computing device (202),
sending a second AI model (226) encrypted with the fourth shared secret key from the second AI model provider (224) to the computing device (202),
decrypting, by the computing device (202), the received encrypted second AI model (226) with the fourth shared secret key,
sending a message authentication code, MAC, of the input data (216) obtained with the second shared secret key from the data provider (204) to the second AI model provider (224),
calculating, by the second AI model provider (224), a first token of the input data (216) as a cryptographic commitment on the MAC received from the data provider (204) using the fourth shared secret key,
sending the first token of the input data (216) from the second AI model provider (224) to the computing device (202),
calculating, by the computing device (202), a second token of the input data (216) for the second AI model (226) using the fourth shared secret key and the second shared secret key,
using, by the computing device (202), the decrypted input data on the second AI model (226) to obtain a third inference result, if the second token of the input data (216) for the second AI model (226) is identical to the first token of the input data (216) received from the second AI model provider (224), or setting null data as the third inference result otherwise, and sending the third inference result encrypted with the second shared secret key from the computing device (202) to the data provider (204).

6. The method (100) of claim 5, further comprising:
sending a first cryptographic hash of the second AI model (226) from the second AI model provider (224) to the data provider (204),
sending a second cryptographic hash of the second AI model (226) decrypted with the fourth shared secret key from the computing device (202) to the data provider (204), and
instructing, by the data provider (204), the computing device (202) to proceed with decrypting the input data (216), if the second cryptographic hash of the second AI model (226) is identical to the first cryptographic hash of the second AI model (226).

7. A computing device (202) for deploying an artificial intelligence, AI, model, the computing device (202) being configured for:
participating in a first key exchange to establish a first shared secret key between the computer device and an AI model provider (206),
participating in a second key exchange to establish a second shared secret key between the computing device (202) and a data provider (204) for receiving an input data (216) to the AI model (222),
receiving the AI model (222) encrypted with the first shared secret key from the AI model provider (206),
decrypting the received encrypted AI model with the first shared secret key,
receiving the input data (216) encrypted with the second shared secret key and a message authentication code, MAC, of the input data (216) obtained with the second shared secret key from the data provider (204), wherein the data provider (204) sends the MAC of the input data (216) obtained with the second shared secret key to the AI model provider (206),
receiving a first token of the input data (216) from the AI model provider (206), wherein the first token of the input data (216) is calculated by the AI model provider (206) as a cryptographic commitment on the MAC received from the data provider (204) using the first shared secret key,
decrypting the encrypted input data and verifying the MAC received from the data provider (204) with the second shared secret key,
calculating a second token of the input data (216) for the AI model (222) using the first shared secret key and the second shared secret key,
using the decrypted input data on the AI model (222) to obtain an inference result, if the second token of the input data (216) for the AI model (222) is identical to the first token of the input data (216) received from the AI model provider (206), or setting null data as the inference result otherwise, and
sending the inference result encrypted with the second shared secret key to the data provider (204).

8. The computing device (202) of claim 7, being further configured for:
sending a second cryptographic hash of the AI model (222) decrypted with the first shared secret key to the data provider (204), wherein the data provider (204) receives a first cryptographic hash of the AI model (222) from the AI model provider (206), and
decrypting the encrypted input data with the second shared secret key only upon receiving instructions of the data provider (204), wherein the instructions are indicative that the second cryptographic hash of the AI model (222) is identical to the first cryptographic hash of the AI model.

9. The computing device (202) of claim 7, being further configured for:
participating in a third key exchange to establish a third shared secret key between the computing device (202) and a second data provider (218) for receiving a second input data (220) to the AI model,
receiving the second input data (220) encrypted with the third shared secret key and a second message authentication code, MAC, of the second input data (220) obtained with the third shared secret key from the second data provider (218), wherein the second data provider (218) sends the second MAC of the second input data (220) obtained with the third shared secret key to the AI model provider (206),
receiving a first token of the second input data (220) from the AI model provider (206), wherein the first token of the second input data (220) is calculated by the AI model provider (206) as a cryptographic commitment on the second MAC received from the data provider (204) using the first shared secret key,
decrypting the encrypted second input data (220) and verifying the second MAC received from the second data provider (218) with the third shared secret key,
calculating a second token of the second input data (220) for the AI model (222) using the first shared secret key and the third shared secret key,
using the decrypted second input data (220) on the AI model (222) to obtain a second inference result, if the second token of the second input data (220) for the AI model (222) is identical to the first token of the second input data (220) received from the AI model provider (206), or setting null data as the second inference result otherwise, and
sending the second inference result encrypted with the third shared secret key to the second data provider (218).

10. The computing device (202) of claim 9, being further configured for:
sending a second cryptographic hash of the AI model (222) decrypted with the third shared secret key to the second data provider (218), wherein the second data provider (218) receives a first cryptographic hash of the AI model (222) from the AI model provider (206), and
decrypting the encrypted second input data (220) only upon receiving instructions of the second data provider (218), wherein the instructions are indicative that the second cryptographic hash of the AI model (222) is identical to the first cryptographic hash of the AI model.

11. The computing device (202) of claim 7, being further configured for:
participating in a fourth key exchange to establish a fourth shared secret key between the computing device (202) and a second AI model provider (224),
receiving a second AI model (226) encrypted with the fourth shared secret key from the second AI model provider (224),
decrypting the received encrypted second AI model (226) with the fourth shared secret key,
receiving a first token of the input data (216) from the second AI model provider (224), wherein the first token of the input data (216) is calculated by the second AI model provider (224) as a cryptographic commitment on a message authentication code, MAC, of the input data (216) obtained by the data provider (204) with the second shared secret key and received by the second AI model (226) from the data provider (204), wherein the cryptographic commitment is obtained by the second AI model provider (224) using the fourth shared secret key,
decrypting the encrypted input data and verifying the MAC received from the data provider (204) with the second shared secret key,
calculating a second token of the input data (216) for the second AI model (226) using the fourth shared secret key and the second shared secret key,
using the decrypted input data on the second AI model (226) to obtain a third inference result, if the second token of the input data (216) for the second AI model (226) is identical to the first token of the input data (216) received from the second AI model provider (224), or setting null data as the third inference result otherwise, and
sending the third inference result encrypted with the second shared secret key to the data provider (204).

12. The computing device (202) of claim 11, being further configured for:
sending a second cryptographic hash of the second AI model (226) decrypted with the fourth shared secret key to the data provider (204), wherein the data provider (204) receives a first cryptographic hash of the second AI model (226) from the second AI model provider (224), and
decrypting the encrypted input data only upon receiving instructions of the data provider (204), wherein the instructions are indicative that the second cryptographic hash of the second AI model (226) is identical to the first cryptographic hash of the second AI model (226).

13. The computing device (202) of claim 7, comprising one or more AI accelerators (208).
